(19) United States
(12) Patent Application Publication
(10) Pub. No.: US 2004/0188889 A1
(43) Pub. Date: Sep. 30, 2004

(54) Process of machining polymers using a beam of energetic ions

(76) Inventors: Carl John Sofield, Harwell (GB); Geoffrey William Grime, Oxford (GB)

Correspondence Address: LAHIVE & COCKFIELD, LLP., 28 STATE STREET, BOSTON, MA, 02109, US

(21) Appl. No.: 10/481,674

(22) PCT Filed: Jun. 21, 2002
(86) PCT No.: PCT/GB02/02908

(30) Foreign Application Priority Data
Jun. 22, 2001 (GB) 0115374.1

(51) Int. Cl. B29C 37/02

(52) U.S. Cl. 264/479; 264/488; 264/138

(57) ABSTRACT

The present invention relates to a process for machining polymers and, in particular, to a process for machining fluorine-containing polymers such as polytetrafluoroethylene using a beam of energetic ions, wherein at least some of the ions are high linear energy transfer (LET) ions. The present invention enables very deep high aspect ratio microfeatures to be produced. The process may also be used on a mesoscopic and macroscopic (normal) scale. Components to be machined may have relatively large dimensions (typically at least several mm thick) as the aspect ratio and etch rate are very high. While the process is a direct writing process, a mask may nevertheless be used for high volume parallel processing. The process does not require the use of a resist layer. The process is less expensive and faster than alternative methods such as synchrottron x-ray lithography.

The present invention relates to a process for machining polymers and, in particular, to a process for machining fluorine-containing polymers such as polytetrafluoroethylene using a beam of energetic ions.

PTFE (polytetrafluoroethylene) is a thermosetting plastic with a high softening point (about 327° C.) prepared by polymerisation of tetrafluoroethylene under pressure (40 to 50 atmospheres). An initiator, for example ammonium peroxosulphate, is required to promote the polymerisation reaction.

PTFE is used in a wide range of areas in the plastics industry due to its chemical inertness, heat resistance, electrical insulation properties and low coefficient of friction over a wide temperature range. Its high thermal stability makes its very useful in high temperature applications.

Because of its chemical inertness and high molecular weight, PTFE does not flow and cannot be fabricated by conventional polymer processing techniques. Processing methods that have previously been used include techniques based on powder metallurgy, cold extrusion processes and latex processing.

Three-dimensional micromachined components are set to play a leading role in the miniaturisation of machines, actuators and sensors. The integration of micromechanical components with electronic devices is known as MEMS (microelectromechanical systems).

A review of micromachining techniques capable of producing sub-micron structures is provided by F Watt in Nuclear Instruments and Methods in Physics Research B 158 (1999) 165-172. Such techniques include optical lithography, X-ray lithography (LIGA), deep UV lithography, electron beam lithography, low energy ion beam micromachining, high energy ion beam micromachining and atomic processing using atom probe microscopy.

High energy ion beam micromachining is also discussed in de Kerckhove et al in Nuclear Instruments and Methods in Physics Research B 136 138 (1998) 379-384. This paper describes a process for the maskless fabrication of three-dimensional microstructures in polymethyl methacrylate (PMMA) using a focussed 3 MeV proton beam. The proton beam is produced in a nuclear (proton) microscope. In a proton microscope, low energy protons are injected into a small particle accelerator, typically a Van de Graaff machine, which accelerates the protons through electrostatic fields of several million volts. The energetic protons emerge from the accelerator in a beam several millimetres across. This beam is then focussed down more than a thousand times, to a diameter of a few microns or less. This finely focussed beam may then be scanned across the surface of a specimen.

With the exception of low energy ion beam micromachining (also known as ion beam lithography or focussed ion beam (FIB) milling) and atomic processing using atom probe microscopy, all of the above techniques require a resist exposure and the subsequent development of the exposed resist using specific chemicals.

Low energy ion beam micromachining relies on heavy ions, for example gallium, to sputter away surface atoms on a sample. The typical energy of a low energy ion beam is from 1 to 50 keV. For each incident gallium ion, up to approximately 50 atoms are sputtered from the surface of the material being micromachined. The technique is essentially a surface milling technique and cannot be used to produce high aspect ratio structures. Indeed, to produce any three-dimensional structure takes a very long time. The same disadvantages are associated with electron beam writing and atomic processing using atom probe microscopy, which are inherently slow techniques that cannot be used (in practice) to produce high aspect ratio structures or three-dimensional structures.

While optical lithography, synchrotron X-ray lithography (LIGA) and UV lithography have the advantage of a high volume production capability, these techniques require the use of a mask (i.e. they are not direct write techniques) and a resist exposure, which necessitates the subsequent developments of the exposed resist using specific chemicals.

The present invention aims to provide a process for machining polymeric materials which addresses at least some of the problems associated with the prior art techniques.

Accordingly, in a first aspect the present invention provides a process for machining a fluorine-containing polymer, the process comprising:

(i) providing a workpiece comprising a fluorine-containing polymer;

(ii) generating an ion beam; and

(iii) exposing at least a portion of said workpiece to said ion beam, wherein at least some of the ions that impact said portion are high linear energy transfer (LET) ions.

LET is a measure of the energy transferred from an ion to a solid due to ionisation. It depends on the ion species, the energy of the ion beam and the nature of the material. The LET of the ions is preferably high enough to promote rapid decomposition so as to achieve efficient high definition etching. The LET is preferably ≧1 MeVcm²mg⁻¹, more preferably ≧2 MeVcm²mg⁻¹.

In a second aspect the present invention provides a process for machining a polymeric material, the process comprising:

(a) providing a workpiece comprising a polymeric material;

(b) generating an ion beam; and

(c) exposing at least a portion of said workpiece to said ion beam, wherein at least some of the ions that impact said portion cause decomposition of said polymeric material.

The term machining as used herein is intended to encompass machining features (for example holes, slots, trenches, grooves and channels) in a material at the macroscopic level, the mesoscopic level and also the microscopic or sub-micron level.

In the second aspect of the present invention the polymeric material is preferably a fluorine-containing polymer. Preferably, at least some of the ions that impact the workpiece are high linear energy transfer (LET) ions. Again, the LET is preferably ≧1 MeVcm²mg⁻¹, more preferably ≧2 MeVcm²mg⁻¹.

In both the first and second aspects, the LET of the ions is preferably high enough to promote rapid decomposition so as to achieve efficient high definition etching. The peak LET preferably also occurs close to or at the sample surface so as to allow more efficient escape or removal of any reaction products, typically gaseous reaction products.

Fluorine-containing polymers (a term which is intended to encompass fluorinated plastics) include fluorocarbon polymers, including polyfluorocarbon polymers and perfluorinated carbon polymers. The various classes of such materials comprise: (a) chlorotrifluoroethylene polymers; fluorocarbon elastomers; (b) tetrafluoroethylene polymers; (c) vinyl fluoride polymers; and (d) vinylidene fluoride polymers.

Decomposition of the fluorine-containing polymer under the influence of the ion beam preferably yields tetrafluoroethylene, a derivative thereof, and/or other gaseous compounds. The tetrafluoroethylene, a colourless gas, is easily removed from the system.

A preferred polymer material for use in the process according to the present invention is a perfluorinated carbon straight chain polymer, i.e. a polymer comprising or consisting of (CF₂—CF₂) monomer units. A preferred example is polytetrafluoro-ethylene, including copolymers thereof. Copolymers of polytetrafluoroethylene include: (i) tetrafluoroethylene-hexafluoropropylene copolymers (fluorinated ethylene propylene (FEP)); (ii) tetrafluoroethylene-perfluorovinyl ether copolymers; and (iii) tetrafluoroethylene-ethylene copolymers. A preferred copolymer for use in the present invention is FEP.

In both the first and second aspects, at least some of the ions that impact the workpiece are preferably oxygen ions. Other high LET ions may, however, also be used and examples include nitrogen, neon and argon.

The ion beam advantageously has an energy ≧100 keV, preferably ≧200 keV, more preferably ≧250 keV, more preferably ≧300 keV, still more preferably ≧350 keV, still more preferably ≧400 keV. This has been found to result in a high machining rate of the workpiece. For example an erosion rate of PTFE of approximately 0.5 mm per minute is readily achieved using oxygen ions having an energy of at least 300 keV. As such, there is no upper limit for the energy of the beam, although it will generally not exceed 10 MeV. High flux oxygen ions with an energy in the range of from 0.5 to 3 MeV may advantageously be used.

The energy of the ion beam may be altered during the machining process. In this manner, slots, channels, trenches, grooves, tracks and holes, for example, may be machined with different depths. As an alternative, or in combination, the exposure time can be varied to machine different depths.

The ion beam will generally be a focussed ion beam, which may be focussed to a spot size of ≦20 μm, preferably ≦10 μm, more preferably ≦1 μm, still more preferably ≦0.5 μm. Indeed, using a nuclear microprobe it is possible to produce an ion beam with a diameter of approximately 0.1 μm.

During the machining process, the ion beam may be translated relative to the workpiece. This may be achieved by the application of a magnetic and/or electric field. This enables the ion beam to be scanned across the surface of the workpiece.

The position of the workpiece may also be altered during the machining process irrespective of whether the ion beam remains fixed or is itself moved.

The angle of impact of the ion beam on the workpiece may also be altered during the machining process. This may be achieved by simply tilting the beam and/or the workpiece. This enables prismatic features to be machined into the workpiece.

Advantageously, the reaction product (typically a gaseous reaction product) removal rate is sufficient to avoid or help prevent re-deposition of material onto the workpiece. It is thought that such re-deposition may occur as a result of re-polymerisation of the reaction product under (i) ion bombardment and/or (ii) the prevailing processing conditions. Whatever the mechanism, removal of material, such as a gaseous reaction product, formed near the surface of the workpiece is desirable and suitable means for achieving such removal are therefore preferably provided. For example, the machining process may suitably be carried out in a vacuum. In this case, the ion beam is preferably generated from a source of oxygen ions or other high LET ions such as, for example, nitrogen or argon ions. The pressure should preferably be sufficiently low so as to allow any gaseous reaction products, for example tetrafluoroethylene, to escape from the workpiece. Accordingly, the vacuum may be selected such that the mean free path of the gaseous reaction products is larger than the depth of the machined hole, slot, trench, groove or channel. The process may typically be carried out at a pressure of ≦10⁻⁴ Pa, more preferably ≦10⁻⁶ Pa.

Alternatively, the machining process may be conducted in an atmosphere comprising a chemical to inhibit or prevent re-deposition of material (for example a gaseous reaction product) onto the workpiece. Such an inhibitor, for example oxygen, may act to inhibit or prevent re-polymerisation of the reaction product(s) resulting from (i) the ion bombardment and/or (ii) the prevailing conditions (for example pressure and temperature). Such an inhibitor may be present in the ambient gas and/or in the ion beam. Such an inhibitor may act by combining with the reaction product, typically carbon or a carbon-containing species, to form a volatile species, which may more readily be removed from the system.

In a preferred embodiment, the machining process is conducted in an atmosphere comprising oxygen or an oxygen-containing gas. An example of an atmosphere comprising oxygen is air. In this case, the ion beam may be generated from a source of, for example, protons. While not wishing to be bound by theory, it is considered that removal/erosion of the polymer material might be brought about by the energetic recoil of oxygen ions produced by the proton beam as it traverses the air between the ion source and the workpiece. Whatever the mechanism, the presence of oxygen or an oxygen-containing gas in the machining process according to the present invention helps prevent re-deposition of material onto the workpiece. The oxygen may, for example, be present in the source of the ion beam and/or as a gas/oxygen-containing gas in the ambient atmosphere. Again, while not wishing to be bound by theory, the presence of oxygen may act to inhibit the re-deposition of material by forming a volatile species, for example a C—O—F species, and/or CO and/or CO₂.

The process according to the present invention does not require the provision of a mask to allow a selected pattern of exposure. The process may therefore be considered a maskless fabrication process or a direct write process. Nor does the process require the application of a resist layer onto the workpiece and the subsequent chemical etching steps.

Nevertheless, a mask may be interposed between the workpiece and the ion beam to selectively shield the workpiece from the ion beam. A mask may be used to stop ions having an energy up to a certain threshold, which will depend on the thickness of the mask, the material from which it is formed and the nature of the energetic ions. For example, it is envisaged that a workpiece formed from PTFE may be covered with a gold mask of approximately 400 nm thickness. Such a mask is sufficient to stop 300 keV oxygen ions. If a pattern of holes or the like were formed in the gold mask by, for example, lithography, then an oxygen ion beam of the appropriate energy may be directed onto the workpiece to machine many parallel structures (much as is done for standard semiconductor device fabrication). As a consequence, the process according to the present invention not only provides a direct serial writing process, but also provides a high throughput parallel process.

The ion beam may be generated in an ion beam facility comprising an ion source, a particle accelerator, and an ion focussing system. An example is a nuclear microprobe, for example the Oxford University Microbeam Accelerator Facility. Such an apparatus is described in detail in Nuclear Instruments and Methods in Physics Research B 158 (1999) 165-172, Nuclear Instruments and Methods in Physics Research B 136 138 (1998) 379-384, and New Scientist 1 Jun. 1991. Reference may also be made to G W Grime (“Proton Microprobe (Method and Background)” and “High Energy Ion Beam Analysis”) in the Encyclopaedia of Spectroscopy and Spectrometry, editors J C Lindon, G E Tranter, and J L Holmes (Academic Press, Chichester, 1999).

Alternatively, the ion beam may be generated in an ion implantation facility. Such a facility may be used where machining is conducted through a mask, as described above, which results in high volume production (parallel processing).

The process according to the present invention and the products thereby produced are characterised by a number of features. The depth of machined features (for example holes, grooves, tracks, slots and channels) may be several mm deep, while being only of an order of a micron in width. This results in an effective near infinite aspect ratio. The diameter of the machined feature is also substantially constant over its entire length. The machining process is very efficient at removing polymeric material, particularly PTFE. As a consequence, features can be formed quickly and efficiently. The process does not require the use of either a mask or a resist layer. The process also enables three dimensioned features to be formed in a workpiece.

While not wishing to be bound by theory, it is believed plausible that the process according to the present invention is a radiation-induced decomposition of the polymer material, for example PTFE, by a high LET ion such as, for example, oxygen at an energy of typically ≧300 keV. This contrasts with thermally induced decomposition. The radiation-induced decomposition of the polymer chain may result in gaseous breakdown products. This is believed to be a result of primary and secondary ionisation in the polymer material and the rate of evolution of gas along a track or feature in the material is a function of the rate at which energy is transferred from the ion to electrons in the solid (linear energy transfer, LET).

Whatever the reason, the process according to the present invention is highly efficient in that each incident oxygen ion has been calculated to result in the removal of around 1000 atoms of the PTFE material. In PTFE, it has been found that 3 MeV oxygen ions have their peak of LET at the surface and substantially all ionisation occurs close to the surface, typically in the top approximately 2.5 μm. This is an example of an ion with a high LET in the near surface region.

The LET of the ions is preferably high enough to promote rapid decomposition of the polymer so as to achieve efficient high definition etching. The peak LET preferably also occurs close to or at the sample surface so as to allow efficient escape of any gaseous reaction products. In this manner, any gas/vapour evolved as a result of the interaction of the ion beam with the material is readily able to escape from the material (by for example diffusion or effusion) without re-depositing.

The process according to the present invention may be used to machine and fabricate components and devices for a variety of applications, for example miniature machines, actuators and sensors. Machined components may also be used to form moulds and stamps so that a plurality of components may be replicated. Particular applications include complex shaped molecular beam manifolds and filters, moulds for biosensor and laboratory-on-a-chip applications, and drug and bioactive agent delivery devices.

### EXAMPLES AND DRAWINGS, WHICH ARE PROVIDED BY WAY OF EXAMPLE

The following examples were performed using the Oxford University Microbeam Accelerator Facility. This apparatus is described in Nuclear Instruments and Methods in Physics Research B 136 138 (1998) 379-384, and New Scientist 1 June 1991.

The following drawings are provided by way of example:

FIGS. 1 (a) and (b) show a schematic illustration of a suitable experimental layout for Example 1;

FIG. 2 is a graph of the hole depth versus beam exposure time for Example 1; and

FIG. 3 is a schematic illustration of the experimental layout for Example 2.

### EXAMPLE 1

Samples were obtained by cutting approximately 1 cm cubes from a PTFE sheet. A 3 MeV beam of protons (H+) was focussed to about 40 microns diameter and passed through a thin Kapton window (thereby losing about 200 keV to give about 2.8 MeV on the PTFE). In air, collisions with atmospheric oxygen and nitrogen recoils these ions forward with an energy typically in the range of from 300 to 400 keV. The PTFE cubes were placed in the beam path with one face at right angles to the beam and the beam was allowed to impinge for a range of times. The primary proton beam current was measured (using a Faraday cup in air) to be about 1 nanoamp.

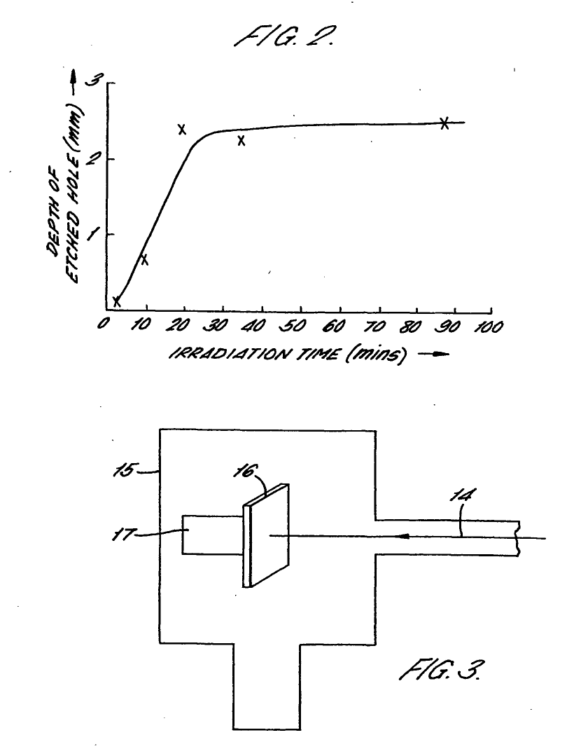

After the exposure to the beam a hole was observed visually in the PTFE which, at the surface of the cubes, had a diameter of about 200 microns. One PTFE cube was abraded down on a cube face parallel to the beam direction using a diamond polishing pad to expose a cross section view of the hole which was found to be about 2.5 mm long and substantially the same diameter over its entire length. The depth of the other holes in the PTFE cubes was measured by threading a human hair down them and measuring the length of the hair by extracting it with tweezers clamped at the PTFE surface. A graph of the hole depth versus beam exposure time is shown in FIG. 2.

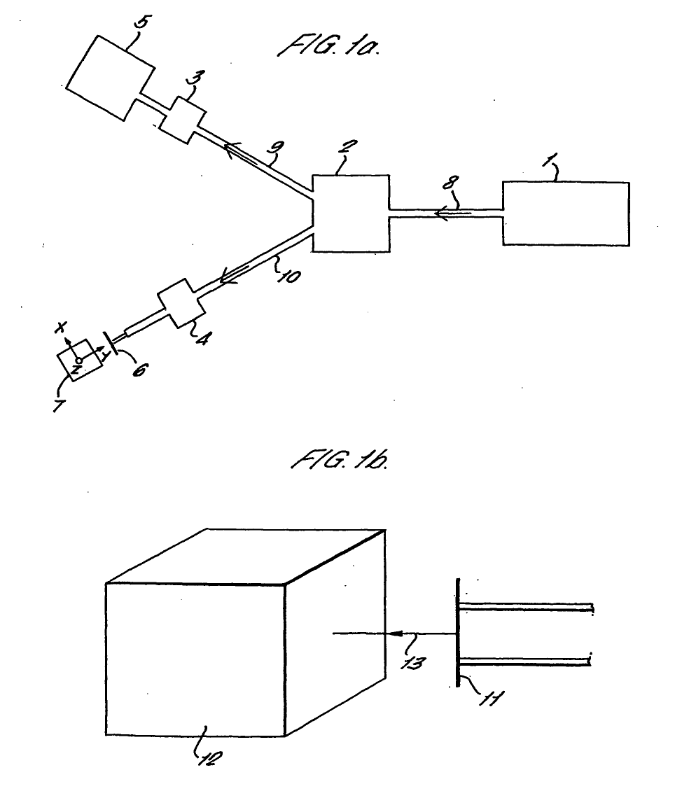

A schematic illustration of a suitable experimental layout is shown in FIG. 1(a), where the reference numerals correspond to the following features:

1. Accelerator with ion source

2. Analysing magnet

3. Microbeam lens

4. Microbeam lens

5. Vacuum target chamber

6. Thin transmission window

7. Air target table

8. Beam line

9. Beam line

10. Beam line

FIG. 1 (b) is a schematic illustration of the ion beam impinging on the PTFE cube, where the reference numerals correspond to the following features:

11. Thin Kapton foil

12. PTFE cube

13. Proton (H⁺) beam

### EXAMPLE 2

A 4 MeV oxygen beam with a charge state of 3+ was generated and focussed onto a ZnS screen in a vacuum chamber at about 10⁻⁶ torr pressure. The spot size was about 20 microns diameter. A 1 mm thick piece of PTFE was then attached to the front of a Faraday cup and about 10 picoamps of leakage current observed. After 20 minutes the beam current rose to 800 picoamps and the beam was then turned off and the PTFE removed from the vacuum chamber. On examination of the PTFE a 15 micron diameter hole was found on the beam entrance side of the PTFE and a 15 micron hole was found on the beam exit side of the PTFE.

A schematic illustration of the experimental set-up is shown in FIG. 3, where the reference numerals correspond to the following features:

14. Oxygen (O³⁺) ion beam from accelerator and microbeam lens

15. Vacuum chamber connected to a vacuum pump

16. PTFE sample

17. Faraday cup

### EXAMPLE 3

Using the H ion beam extracted into air as in Example 1, but with an energy of 2 MeV, holes were formed in PTFE tape (about 50 micron thick).

Next, the distance between the Kapton beam exit window and a PTFE sample tape was varied. This, in turn, varies the energy of recoil of the oxygen ions; the bigger the distance the lower the H ion energy and the recoil oxygen ion energy. It was observed that a gap of about 4 mm significantly reduced the etch rate and by 8 mm no etching was observable.

A roll of PTFE tape has also been exposed to the beam for 7 minutes. Unravelling the tape revealed 42 holes, corresponding to a depth of about 2 mm. Again the holes were of substantially equal diameter in each layer.

### EXAMPLE 4

Using a 2 MeV, H⁺ beam, a hole was drilled in FEP. The hole had a depth of greater than 100 μm and a diameter of approximately 70 μm. The beam developed a current of 1 nA which was brought out through a Kapton window into air and allowed to impinge on the FEP sample.

The present invention provides an efficient process for micromachining polymeric materials, such as PTFE. The present invention enables very deep high aspect ratio microfeatures to be produced. The process may also be used on a mesoscopic and macroscopic (normal) scale. Components to be machined may have relatively large dimensions (typically at least several mm thick) as the aspect ratio and etch rate are very high. While the process is a direct writing process, a mask may nevertheless be used for high volume parallel processing. The process does not require the use of a resist layer. The process is less expensive and faster than alternative methods such as synchrotron x-ray lithography.

1. A process for machining a fluorine-containing polymer, the process comprising:
(i) providing a workpiece comprising a fluorine-containing polymer;
(ii) generating an ion beam; and
(iii) exposing at least a portion of said workpiece to said ion beam, wherein at least some of the ions that impact said portion are high linear energy transfer (LET) ions.

2. A process for machining a polymeric material, the process comprising:
(a) providing a workpiece comprising a polymeric material;
(b) generating an ion beam; and
(c) exposing at least a portion of said workpiece to said ion beam, wherein at least some of the ions that impact said portion cause decomposition of said polymeric material.

3. A process as claimed in claim 2, wherein at least some of the ions that impact said portion are high LET ions.

4. A process as claimed in claim 1, wherein the LET is ≧1 MeVcm²mg^{-1.}

5. A process as claimed in claim 2, wherein the polymeric material is a fluorine-containing polymer.

6. A process as claimed in claim 1, wherein decomposition of the fluorine-containing polymer under the influence of the ion beam yields tetrafluoroethylene or a derivative thereof.

7. A process as claimed in claim 1, wherein the fluorine-containing polymer is or comprises a tetrafluoroethylene polymer.

8. A process as claimed in claim 1, wherein the fluorine-containing polymer is or comprises a perfluorinated carbon straight chain polymer.

9. A process as claimed in claim 8, wherein the fluorine-containing polymer is or comprises polytetrafluoroethylene or a copolymer thereof, preferably tetrafluoroethylene-hexafluoropropylene.

10. A process as claimed in claim 1, wherein at least some of the ions that impact said portion are selected from one or more of oxygen, nitrogen and argon ions.

11. A process as claimed in claim 1, wherein the ion beam has an energy ≧100 keV.

12. A process as claimed in claim 11, wherein the ion beam has an energy ≧200 keV, preferably ≧250 keV, more preferably ≧300 keV, still more preferably ≧350 keV, still more preferably ≧400 keV.

13. A process as claimed in claim 1, wherein the energy of the ion beam is altered during the machining process.

14. A process as claimed in claim 1, wherein the ion beam is a focussed ion beam.

15. A process as claimed in claim 14, wherein the ion beam is focussed to a diameter of ≦20 μm, preferably ≦10 μm, more preferably ≦1 μm.

16. A process as claimed in claim 1, wherein, during the machining process, the ion beam is translated relative to the workpiece.

17. A process as claimed in claim 16, wherein the ion beam is translated relative to the workpiece using a magnetic and/or electric field.

18. A process as claimed in claim 16, wherein the ion beam is scanned across the surface of the workpiece.

19. A process as claimed in claim 1, wherein, during the machining process, the position of the workpiece is altered.

20. A process as claimed in claim 1, wherein, during the machining process, the angle of impact of the ion beam on the workpiece is altered.

21. A process as claimed in claim 1, wherein the machining process is conducted in a vacuum or a partial vacuum.

22. A process as claimed in claim 21, wherein the machining process is conducted at a pressure of ≦10⁻⁴ Pa, preferably ≦10⁻⁶ Pa.

23. A process as claimed in claim 21, wherein the ion beam is generated from a source of high LET ions, selected from one or more of oxygen, nitrogen and argon ions.

24. A process as claimed in claim 1, wherein the machining process is conducted in a gaseous atmosphere, preferably a gaseous atmosphere with a pressure of ≧1 mbar.

25. A process as claimed in claim 24, wherein the gaseous atmosphere comprises or consists of oxygen or an oxygen-containing gas.

26. A process as claimed in claim 24, wherein the ion beam is generated from a source of protons.

27. A process as claimed in claim 1, which is a maskless fabrication process.

28. A process as claimed in claim 1, wherein a mask is interposed between the workpiece and the ion beam and selectively shields the workpiece from the ion beam.

29. A process as claimed in claim 1, wherein the ion beam is generated in an ion beam facility comprising an ion source, a particle accelerator, and an ion focussing system.

30. A process as claimed in claim 29, wherein the ion beam is generated in a nuclear microprobe.

31. A process as claimed in claim 1, wherein the ion beam is generated in an ion implantation facility.

32. A machined workpiece whenever produced or obtainable by a process as claimed in claim 1.
